(19) United States
(12) Patent Application Publication
(10) Pub. No.: US 2010/0187090 A1
(43) Pub. Date: Jul. 29, 2010

(54) METHOD FOR PROCESSING COAL WITH A HIGH CONTENT OF IMPURITIES TO OBTAIN A PURIFIED FUEL MIXTURE UTILIZABLE IN PLACE OF FUEL OIL IN PRESENT-DAY POWER PLANTS

(76) Inventors: Mario Mazza, Milano (IT); Bruno Dalmino, Milano (IT)

Correspondence Address: YOUNG & THOMPSON, 209 Madison Street, Suite 500, Alexandria, VA, 22314, US

(21) Appl. No.: 12/667,460

(22) PCT Filed: Sep. 12, 2007
(86) PCT No.: PCT/IT2007/000628

§ 371 Date: Dec. 31, 2009

(30) Foreign Application Priority Data
Aug. 2, 2007 (IT) MI2007A001593

(51) Int. Cl. C10L 1/32; B01J 19/10

(52) U.S. Cl. 204/157.42; 422/128

(57) ABSTRACT

Coal slurry is produced for use as fuel. Starting from a raw carboniferous mineral containing various types of impurities, the method of production includes the following stages: a) grinding the raw coal to reduce it to particles of a size less than 75 μm, the ground material then being carried by air drawn in through a grinding mill and on through a filter where a selection is made of the particles; b) immersion of the particles in water to obtain a turbid mixture; c) addition of flotating agents to the turbid mixture and flotation by introduction of air to obtain the coal slurry; d) checking the concentration of coal in the slurry to ensure that it reaches between 40 and 60% by weight per kilogram of slurry, according to the type of carboniferous mineral used at the outset; e) stocking the slurry in a tank where it is kept continuously moving.

### FIELD OF APPLICATION

The present invention concerns the production of fuel for power plants, or stated more precisely, a method for processing coal containing a large quantity of impurities in order to obtain a purified fuel mixture to replace fuel oil in present-day power plants and thermoelectric power plants.

### REVIEW OF THE KNOWN ART

The following fuels are used at present in power plants:
Natural gas: this can only be obtained from the chief exporter countries, namely Algeria, Russia and Norway, and involves costly transport through pipelines or in special ships for carrying liquid gas. Considerable risks are attached to these ships, and ports are unwilling to accept them for unloading on account of the dangers present in degassing operations.
Fuel oil with a high or low sulphur content (HSC/LSC): a petroleum by-product with similar limitations regarding supply, costly, with a high level of gaseous emission and residual fuel ash.
Coarse-ground coal (0.5-2 mm) containing large quantities of mineral impurities, usually described as ash, between 8 and 12% by weight, and 1 to 2% of sulphur. This too has a high level of gaseous emission; it produces large quantities of ash and its environmental impact in relation to recognised safety levels is high. Its only advantage lies in its low cost.
Coal slurry (or coal-water). This is a semi-fluid fuel obtained by purifying coal; it consists of a mixture of water and insoluble materials of varying granular size held in suspension by means of dispersing and stabilizing additives. The techniques for producing slurry have already been long tried out in the United States in order to avoid pollution by coal dust, but without obtaining any reduction in the residual ash and sulphur. Coarse coal slurry is suitable for transport by ships as it is simple to load and unload. Once loaded, however, the slurry must be dried out to avoid carrying needless quantities of water, which then has to be added again for unloading operations.

U.S. Pat. No. 3,696,923, inventor Francis G. Miller, published 10 Oct. 1972, claims a method for treating coal slurry that substantially contains all the fine coal and smaller particles of about 14 mesh (1,180 μm), the rest being water, in a coal washing circuit in which slurry is obtained after cleaning the coal by flotation to separate out the gangue as an inert product and to obtain frothy material containing roughly from 15 to 35 percent of fine coal and coal particles. This product is dehydrated to recover a substantial part of the fine coal and particles as a dry product, and an effluent containing water, and from 3 to 5 percent of fine coal and of coal particles, the improvement including passage through a system in which solids are recovered and which includes further cells of frothy flotation to recover all the fine coal and that containing particles and, as a residual product, clarified water containing not more than 0.1 percent of solids which can be recycled if required. The purpose of this method is not to produce coal slurry but rather aims at obtaining a semisolid product (70% coal); slurry is produced in an intermediate stage and contains particles that would be too large for use in power plants to replace fuel oil unless the whole plant were redesigned to take them. Neither does the method seem suitable for obtaining coal that, initially possessing a large quantity of impurities, leaves only a small residue of ash and sulphur after burning.

### PURPOSE OF THE INVENTION

As stated above, the purpose of the invention is to obtain a type of coal slurry that can be burnt in present-day power plants and in thermo-electric plants instead of the HSC/LSC fuel oil now used, but without appreciably increasing the cost of making adaptations to the plant.

A further purpose of the invention is to lower fuel costs. On the domestic market today, the average cost of a tonne of fuel oil with a heating value of Kcal/Kg 8,500 is [symbol] 600. The aim is therefore to halve this cost, and whether or not this can be done depends on the possibility of producing slurry from coal that initially contains a high percentage of impurities and is therefore inexpensive.

Another aim of the invention is to produce a type of slurry with a much lower content of ash and sulphur by weight compared with present fuels.

### SUMMARY OF THE INVENTION

To achieve these ends, subject of the present invention is a method for producing a mixture of finely ground coal and water, known as coal slurry, for use as a fuel in power plants, comprising the following steps:
a) grinding a carboniferous mineral containing a variety of impurities to particles smaller than 75 μm;
b) immersion of the ground material in water to produce a turbid mixture;
c) addition of flotating agents to the turbid mixture to allow particles of ground coal to float by input of air so as to form coal slurry;
d) checking the quantity of coal in the slurry to achieve a concentration of between 40 and 60%, by weight of coal per kilo of slurry, according to the type of carboniferous mineral used at the outset;
e) stocking the slurry in a tank where it is kept constantly moving to make it suitable for use instead of conventional fuels, as described in claim 1.

Another aim of the invention is a system for making coal slurry based on the above method, as described in the respective claims.

Further characteristics of the present invention, considered innovative, are described in the dependent claims.

The steps comprised in the method are preferably carried out in continuity so as to achieve optimum density maintaining a check on the quantity of carbon ground to a particle size of less than 75 μm carried forward to a tank for premixing the turbid material, and on the capacity of a delivery pump that takes it on to the flotation cell.

According to one aspect of the invention, the slurry is taken up through the upper mouth of a fillway.

According to one aspect of the invention the densest gangue is recovered from the bottom of the flotation cell and from that of the fillway.

According to another aspect of the invention the turbid mixture taken from an intermediate point in the flotation cell is carried to a filter to recover the coal still present and pour it into the slurry tank.

According to another aspect of the invention the gangue so recovered and the residual material from a previous filtering operation are carried to a thickener where the inert material is separated from the water for recycling. According to another aspect of the invention, particularly useful if a considerable percentage of sulphur in the form of iron sulphides (pyrites), zinc, copper, etc, is present in the raw coal, the residual mixture from flotation is bombarded with ultrasounds, at a frequency depending on the type of coal, in order to break up the metal sulphides and precipitate their single components. Experiments have shown that supersonic frequency lies between 20,000 and 50,000 Hz, this treatment being useful where the alloyed sulphur present exceeds 2% by weight.

The possibility of obtaining a coal slurry capable of replacing fuel oil without appreciable effects on the power plant is strictly linked to having ground particles of the correct size. Laboratory tests made in an experimental plant, have shown that degrees of fineness below 50 μm are harmful because an excessive quantity of dust finer than 20 μm would be produced which means that the finer granules might not be properly mixed with chemical reagents for flotation and might become attached to the inert materials that have to be separated out, thereby causing a loss of coal. On the other hand, grinding to 100 μm can produce coal particles decidedly more voluminous than the particles of inert materials (quartz and kaolinite) of much smaller sizes. For example, a coal particle measuring 100 μm would weigh more than a siliceous particle measuring 60 μm so that, in spite of flotation, it would in any case tend to deposit and become dispersed with the inert materials. The suggested degree of fineness of 70-75 μm is the best for solving the technical problem of recovering the coal.

### Advantages of the invention

The invention describes coal slurry as a semi-fluid fuel derived from purification of coal that appreciably reduces (below 50%) the content of ash and sulphur. Present desulphurization plants are suited to transformation of the sulphur present in the inert material into gypsum (CaSO₄). Environmental impact, a feature of which is the absence of fine dust, is similar to that when fuel oil is used but, compared with this latter, the sources are many and varied.

The slurry according to the invention advantageously replaces the HSC/LSC fuel oil most frequently used in thermoelectric power plants, its appearance being similar. Generated heating power being equal, fuel costs are thus reduced to less than half. Use of coal slurry instead of fuel oil requires only slight and inexpensive changes to the burners and to other parts of the boiler, those needed mainly concerning a greater capacity of the pumps used to feed in the slurry.

Compared with actual coal, the slurry made according to the invention is only apparently more expensive since there is a significant reduction in the cost involved in getting rid of the ash. This reduction is due to necessary purification of the carboniferous material initially used in the production of slurry. In this process impurities must be separated out and could therefore be individually treated in a more advantageous manner, for example by possibly recovering quartz and pyrites for sale. The advantages are therefore evident even if raw coal, containing impurities of 15-18% by weight including 5-7% of sulphur, is used to make the slurry, one advantage being an increase of up to 10% in the heating power of the purified coal.

With regard to the carbon oxide released into the atmosphere, the particles of burnt slurry contained in the smoke at high temperatures (600° C.), can be filtered through fine steel wire fabrics that withstand heat up to 1,000° C. The filtrate is then put into an aqueous solution containing 45% of caustic soda to obtain calcium carbonate and sodium sulphate of considerable commercial value, such as that used in the production of detergents.

### SHORT DESCRIPTION OF THE FIGURES

Further purposes and advantages of the present invention will be made still clearer by the following detailed description of an example of its realization and by the attached drawings provided for purely explanatory reasons and in no way limited to these, wherein:

FIG. 1 shows a block representation of the whole plant for producing coal slurry according to the method of the invention, in which each block indicates a section of one line of the plant, full details being given in the figures marked above each one. The letters linking one figure to another are also shown. A complete plant can comprise N lines of production, operating in parallel, similar to those diagrammatically shown in FIG. 1.

FIGS. 2 to 5 show the arrangement of the means used in each of the four sections, divided solely for convenience, of a production line as schematized in FIG. 1.

### DETAILED DESCRIPTION OF A PREFERRED REALISATION OF THE INVENTION

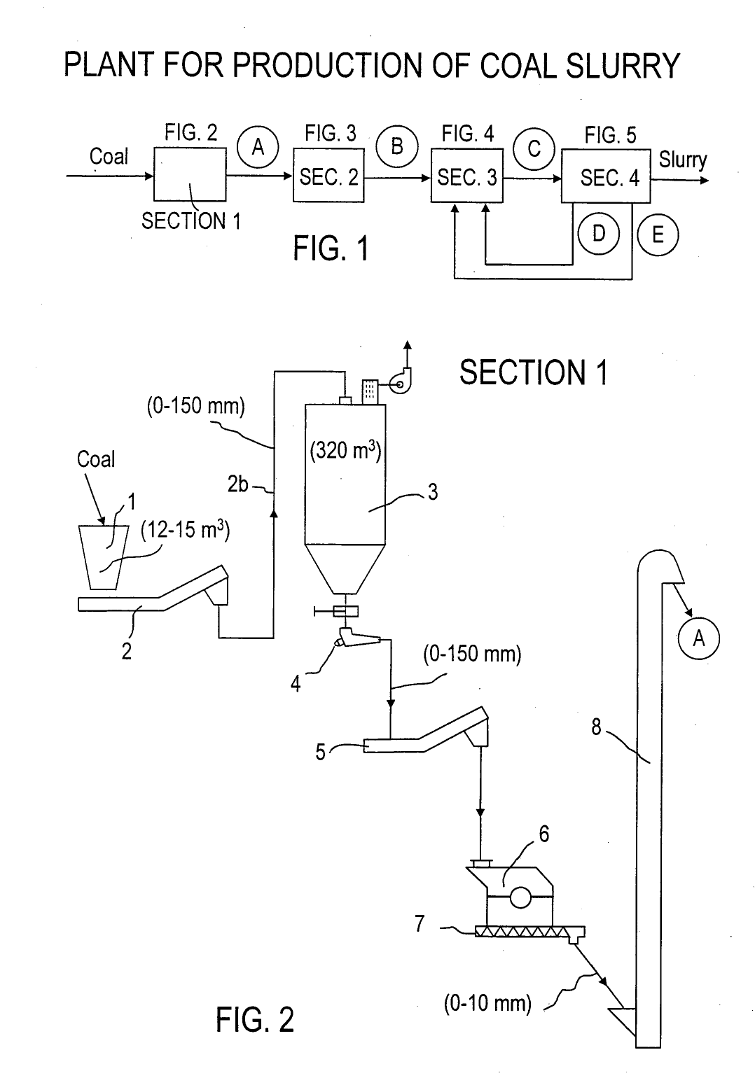

Starting from FIG. 2, the head of one slurry production line comprises a hopper 1 to receive the carbon present at the site. Hopper 1 is loaded mechanically and from there a sliding chain extractor 2 takes the coal to an elevator 2b from where it is poured into a silo 3 that acts as a plenum chamber. The elevator 2b can be of the bucket, belt or chain type according to space available at the plant. Figures marked against each part show characteristics of the semi-finished products, output of the means used, details of the flows concerned.

Experiments have been carried out at the plant now being described using coal from six sources, all of which gave excellent results. A description will be given of the use of a type of raw coal which, at the outset, seemed the least suitable. This type comes in pieces measuring up to 150 mm, with 16 or 17% by weight of solid impurities, 6-7% being sulphur, and having an initial heating power of 5,500 Kcal/Kg. Output from the single production line shown in the drawings can reach 25 tonnes per hour (25 t/h) of purified coal with a degree of fineness of about 75 μm, containing 6-7% of inert material of which residual sulphur represents 0.8-0.9%.

Heating power of the coal contained in the slurry in its final form is 6,200

Kcal/Kg.

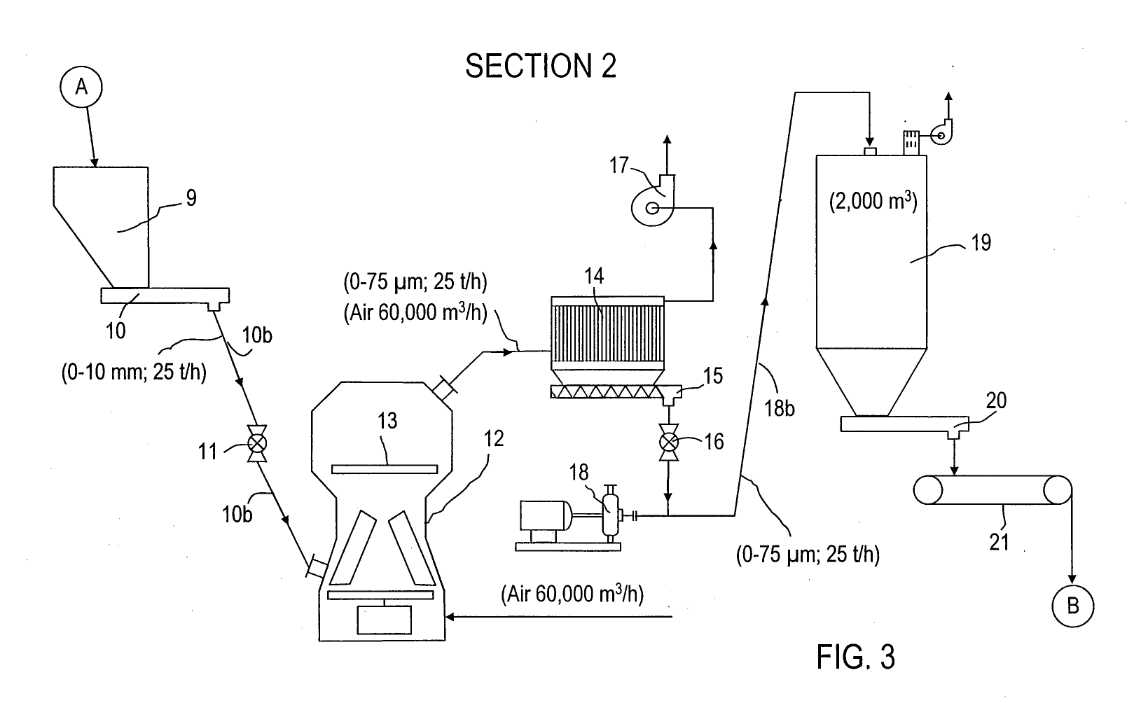

To serve the production cycle in the most efficient manner, volume of the hopper 1 is 12-15 m³ and that of the silo 3 is 320 m³, quantities sufficient for 12 hours production time. At the exit from the silo 3 is a vibrating extractor 4 connected to a conveyor 5 that carries the coal to the entrance of a coal breaker mill 6. If the mill 6 is placed directly below the extractor 4, there would be no need for the conveyor 5. The mill 6 operating by articulated hammers breaks up the coal into pieces of up to 10-12 mm giving an output of 30 t/h, the pieces then falling into a screw feeder 7 below and carried by means of an elevator 8 to a hopper 9 (FIG. 3) acting as a plenum chamber. The hopper is fitted with two devices to show maximum and minimum levels so that the extractor 4 can be properly worked either by an operator or automatically by an electronic system. Beneath the hopper 9 is a dual rotating-disc feeder 10 to control feed to a second mill 12, the material passing through a pipe 10b on which is mounted an airtight rotating cell 11.

The mill 12 receives material already roughly ground in the mill 6, and regrinds it to a granular size of less than 75 μm from where it is carried by air to a fabric sleeve filter 14 connected to a centrifugal fan 17 that draws in through the filter 14 as much as 60,000 m³ of air needed for filtering 25 t/h of finely ground material.

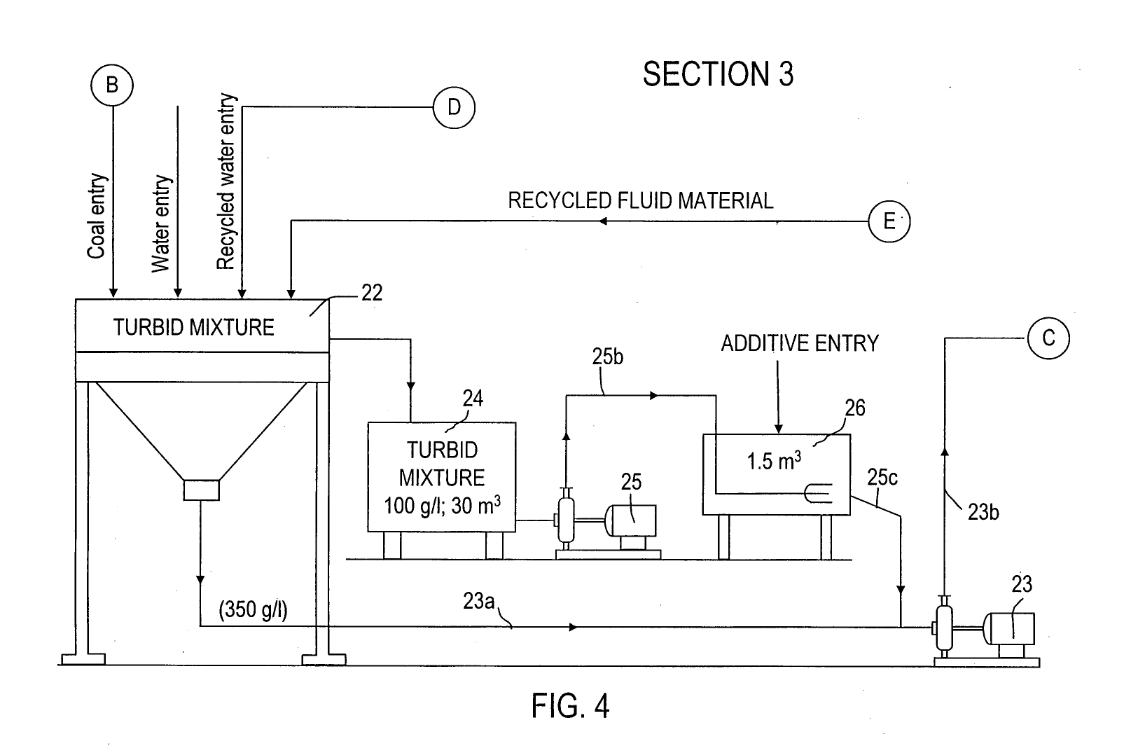

The mill 12 is of the double-roller type having inside it an adjustable rotating selector 13 by means of which the ground material is raised up as soon as it reaches the required degree of fineness so that only sufficiently fine material reaches the filter 14, from where it passes into a special type of screw feeder 15 below, and from there into the circuit 18b of a pneumatic conveyor 18 through an airtight rotating valve 16. The conveyor 18 fills a silo 19, capacity 2000 m³, sufficient for at least 48 hours of production time. This silo is of a particular type having a fluidized bottom that adapts itself to a disc extractor 20 that feeds a conveyor 21. This carries the material towards a pre-mixing tank 22 (FIG. 4) where it is mixed with water without additives by a moderately slow mechanical mixing means. More precisely, the tank 22 receives material ground to less than 75 μm, as well as processing water and material recycled after imperfect flotation, so producing a turbid mixture of coal particles containing impurities.

From the bottom of the tank 22 the most highly concentrated part of the turbid mixture (350 g/1) enters a pipe 23a that from the bottom of the tank conveys it to a pump 23 that pumps it into the flotation cell. The more fluid part of the turbid mixture (100 g/l) is taken from higher up in the tank 22, and is transferred to another tank 24, capacity 30 m³, used exclusively for storing fluid mixed with additives for flotation; from there it is pumped by a pump 25 into a pipe 25b and taken to a mixer 26, capacity 1.5 m³, of the type known as jet-mixer, that mixes in the quantity of additives needed to obtain the concentrations respectively required for the flotated product. The turbid material mixed with additives leaves the mixer 26 through a pipe 25c that flows into a pipe 23a, the whole then being pumped by the pump 23 into a pipe 23b towards the flotation cell.

The additives used belong to two distinct chemical families: a) naphthalene sulphonates, and b) mixtures of alcohols, esters, ethers and aliphatics.

The naphthalene sulphonates are used as surface-active agents in the following functions: as sequestering, wetting and dispersing agents. As sequesters they remove the fat that accumulates on the particles; as wetting agents they assist penetration of water into the interstices of each single particle, and as dispersing agents they allow the particles to float on the water. Stated briefly, the naphthalene sulphonates keep the slurry homogeneous and are present to a maximum of one per cent by weight compared with that of coal in the slurry (from 40 to 60% of its weight) in its final form.

The mixture of alcohols, esters, ethers and aliphatics acts in synergy when separating the various components of the coal according to their specific weight (gravimetric analysis) and in this case too the quantity present amounts to about one percent.

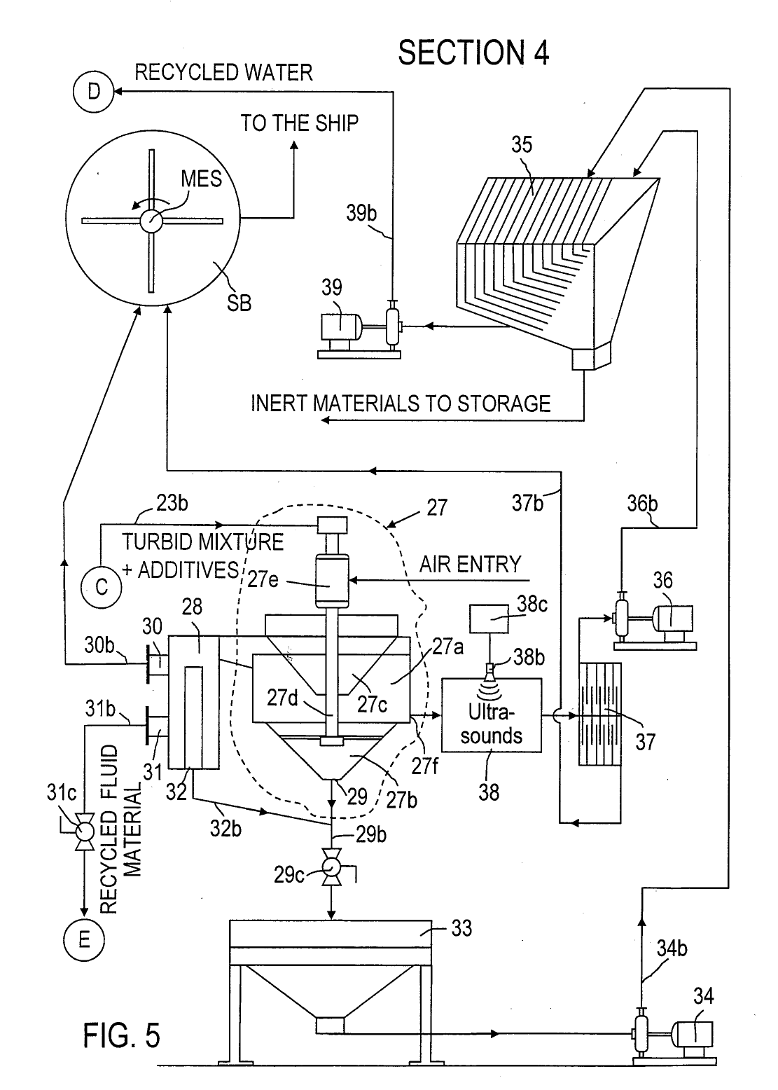

Maximum capacity of the main pump 23 is 600 m³/h; it is kept under cover for pumping the turbid mixture, with additives for flotation, into the pipe 23b towards a flotation cell 27 (FIG. 5), processing capacity of this cell being 75 m³/h. Flotation consists in blowing air into the turbid material containing flotating or foaming agents, possibly using a mechanical mixer as well, so that the particles of coal, rendered hydrophobic, are caught up by the air bubbles and brought more or less stably to the surface, while the gangue, rendered hydrophilic, is wetted and precipitates to the bottom. In this way the slurry is separated from the residual inert material. The flotation cell 27 may be of the type available on the market, such as the Pneuflot® tank that offers a number of advantages. More generally speaking the flotation cell 27 comprises an outer tank, the upper part 27a of which is cylindrical and the lower part 27b conical, and a smaller internal truncated-cone shaped tank 27c. An upright pipe 27d connects with a flotation turbine 27e, aligned with the pipe 27d and above it, outside the tank 27c. The pipe 23b, carrying the turbid mixture with additives to be flotated, enters the turbine 27e from above. The turbine 27e has an entry point for air, and vanes so placed as to create a local depression to draw the air in. As an alternative the turbine could be eliminated by forming a neck in the pipe 27d to exploit the Venturi suction effect.

The coal slurry obtained from flotation can be recovered by a fillway 28 that communicates with the upper internal tank 27c inside the flotation cell 27. The fluid gangue can be recovered through a mouth 29 in the bottom of the lower tank 27b. The fillway 28 has an upper mouth 30, an intermediate mouth 31 and a lower mouth 32 for taking up the products from flotation. Through the upper mouth 30, the coal slurry at the desired concentration—between 40 and 60% by weight of dry coal on the weight of the slurry—enters a pipe 30b that carries it to a tank SB where it is kept moving by an MES rotary-blade mixer. An imperfectly flotated product enters the pipe 31b from the mouth 31, this product having to be recycled and flotated again. This is done by a recycling rotating cell 31c that pumps the product towards the tank 22 for turbid material (FIG. 4). The sedimentary gangue in the cone-shaped tank 27b passes through the mouth 29 in the bottom into a pipe 29b that conveys it, through a tube 32b connected to the mouth 32, into another rotating cell 29c. The gangue collected in the tank 33 is pumped out by a pump 34, with a maximum capacity of 100 m³h, into a tube 34b that carries it to a bladed thickener 35.

The flotation cell 27 has yet another exit 27f situated low down on the tank 27a, from which a paste product, still rich in coal to be recovered, is sucked up by a pump 36 and passed through a disk filter 37 where the coal slurry is separated from residual water and sterile materials. The disk filter 37 is a device, widely used for cleaning purposes in the treatment of refluent water, in which a series of micro-screens made of extremely fine steel wire enable the solid product to be recovered. According to the present invention, the turbid material taken from the tank 27c, (after treatment with ultrasounds, where advisable) flows by gravity through the series of micro-screens that allow the coal slurry to pass but holding back the larger and heavier particles. The slurry recovered from the filter 37 flows into a pipe 37b towards the tank SB where the MES mixer keeps it in a state of continuous movement.

The thickener 35 is a well-known device consisting of a suitably shaped tank inside which is a sequence of well spaced out parallel blades. These blades are downwardly inclined to allow the inert material to be gradually deposited on the bottom of the tank. A recycling pump 39 carries off water from the thickener 35 and returns it through a pipe 39b to the tank 22 of turbid material (FIG. 4). The inert material remaining on the bottom of the thickener 35 either goes to a special dump or is recovered for further use in some industrial process.

Only in those cases where the carboniferous material contains a large quantity of alloyed sulphur will the slurry be treated with ultrasounds if the sulphur cannot be reduced by flotation alone (as stated earlier). In this case the sulphur-rich slurry is poured into a tank 38, sized m³ 10, 20 or more, to whose vertical sides piezoelectric transducers 38b are fitted and are electrically connected to a wave generator 38c at frequencies variable between 20 and 50 kHz according to the type of raw coal. The high-frequency pressure waves transmitted by the transducers 38b to the walls of the tank 38, and to the mixture it contains, set up a phenomenon of cavitation in which micro-bubbles of steam form in the liquid; these suddenly implode creating local differences in pressure which may reach 1,000 bar, breaking up the micro-granules of pyrites and causing the sulphur and iron to precipitate separately.

Production of coal slurry can be controlled in various ways: complete manual control, semi-automatic control, complete automatic control, and according to which is chosen the devices used will be fitted with sensors and actuators connected to an electronic process controller suitably programmed for carrying out the various stages of the method described above. Whichever type of control is chosen, density of the turbid mixture must be carefully proportioned and a control maintained on the quantity pumped to the flotation cell 27 to avoid saturation of flotation capacity (with possible losses of coal) and to ensure that the slurry in its final form contains the correct concentration of coal. When it is known how much the pump 23 normally carries to the flotation cell 27, density can be established by regulating the speed at which the disk extractor 20 takes coal from the silo 19 as well as the quantity of fluid material entering the premixing tank 22. This quantity includes recycling fluid material from lines D and E plus topping-up water (once the initial quantity has been used up). The quantity of fluid material from line D is regulated by the pump 39, and that from line E by the rotating cell 31c. The quantity of water added for topping up is negligible.

1-17. (canceled)

18. Method for producing a mixture of water and finely ground coal, also called coal slurry, for use as fuel in power plants, comprising the following stages:
a) grinding (6, 12, 13) a carboniferous mineral until particle size is reduced to less than 75 μm, starting from a carboniferous mineral containing a variety of impurities in which the alloyed sulphur exceeds 2% by weight;
b) introduction (22) of the ground material into an aqueous flow to obtain a turbid mixture;
c) addition of flotation agents to the turbid mixture (24, 26) to assist selective floating of the particles of ground coal and their flotation (27) by introduction of air, to obtain said coal slurry;
characterized in that further comprising the following steps:
d) bombardment of a residual turbid mixture from flotation including a paste product still rich in coal to be recovered, with ultrasounds (38, 38b, 38c) at a frequency between 20,000 and 50,000 Hz in order to break up metal sulphides and precipitate their single components;
e) control of concentration of coal in the slurry to between 40 and 60% by weight of coal per kilo of slurry;
f) stocking (SB) the slurry in a tank and keeping it continuously moving (MES) to make possible its use in place of conventional fuel oils.

19. The method as in claim 18, wherein said grinding stage a) comprises preliminary grinding (6) of the raw carboniferous mineral to break it up into particles smaller than 12 mm.

20. The method as in claim 18, wherein, during stage a), filtering (14) is executed simultaneously of the ground material carried by air (17) through a grinding mill (12) and through a filter (14) for selection of said particles of a size below 75 μm.

21. The method as in claim 18, wherein the various stages are carried out continuously.

22. The method as in claim 21 wherein concentration of coal in the slurry is obtained by checking (20) the quantity of carboniferous mineral ground to a size below 75 μm and carried to a tank for premixing the turbid mixture (22), together with the quantity of said turbid mixture pumped by the delivery pump (23) to a flotation cell (27).

23. The method as in claim 18, wherein said flotation agents are added in the following ways:
division of the turbid mixture into a primary flow (23a) and into a secondary flow (25b) of lesser density than the primary flow (23a);
feeding a flotation agent mixer (26) with said secondary flow (25b);
reuniting said primary flow (23a) with the secondary flow (25c) to which said flotation agents have been added, to obtain a third flow (23b) directed towards a flotation cell (27).

24. The method as in claim 18 wherein flotation additives include naphthalene sulphonates and a mixture of alcohols, esters, ethers and aliphatics.

25. The method as in claim 18 wherein a residual flotation mixture is removed (27f) and filtered (37) to extract a residual coal slurry.

26. The method as in claim 25, wherein the residual turbid mixture after flotation (34b, 36b) is thickened (35) to recover sedimented inert materials.

27. System for the production of a mixture consisting of finely ground coal and water, also termed coal slurry, for use as a fuel in power plants, comprising:
grinding means (6, 12, 13) for reducing a raw carboniferous mineral containing various kinds of impurities, to particles less than 75 μm;
means (22) for mixing the ground material with water to obtain a turbid mixture;
means (27, 28) for flotation of the turbid mixture to which flotating agents are added so that selected particles of ground coal can float;
means for generating ultrasounds (38c) at a frequency between 20,000 and 50,000 Hz connected to transducer means (38b) applied to the walls of a tank (38) for collecting a residual turbid mixture from flotation, for the purpose of separating sulphur and metals from the coal;
means (20, 23, 31c, 39) for controlling the concentration of coal in the slurry to between 40 and 60% by weight of coal per kilogram of slurry;
means (SB) for stocking the slurry and keeping it moving (MES).

28. The system as in claim 27, wherein said grinding means comprise a first mill (6) suitable for crushing the carboniferous mineral to particles of less than 10-12 mm, downstream of which is a second mill (12) that further reduces the sizes of the particles as stated.

29. The system as in claim 28, wherein the following are included:
filtering means (14, 15) for selecting the ground material finer than 75 μm passing from there downstream into the second mill (12);
means (17) for drawing air through said second mill (12) and said filtering means (14,15).

30. The system as in claim 27, wherein means (37) are included for filtering said residual turbid mixture from flotation to extract a residual coal slurry.

31. The system as in claim 27, wherein said means for controlling the concentration of coal in the slurry include:
an extractor (20) for extracting the carboniferous mineral ground to below 75 μm from the silo (19);
means (23) for pumping said turbid mixture to said means of flotation (27, 28);
means (31c, 39) for recycling the water drained from flotation.

32. The system as in claim 30, wherein thickening means (35) are included for recovering sedimentary inert materials from said residual turbid mixture from flotation.

33. The system as in claim 31, wherein thickening means (35) are included for recovering sedimentary inert materials from said residual turbid mixture from flotation.
